(19) United States
(12) Patent Application Publication
(10) Pub. No.: US 2011/0161079 A1
(43) Pub. Date: Jun. 30, 2011

(54) Grammar and Template-Based Speech Recognition of Spoken Utterances

(75) Inventors: Rainer Gruhn, Ulm (DE); Stefan Hamerich, Ulm (DE)

(73) Assignee: NUANCE COMMUNICATIONS, INC., Burlington, MA (US)

(21) Appl. No.: 12/634,302

(22) Filed: Dec. 9, 2009

(30) Foreign Application Priority Data
Dec. 10, 2008 (EP) 08021450.5

(51) Int. Cl. G10L 15/26; G10L 15/18

(52) U.S. Cl. 704/235; 704/257; 704/E15.018; 704/E15.043

(57) ABSTRACT

The present invention relates to a communication system, comprising a database including classes of speech templates, in particular, classified according to a predetermined grammar; an input configured to receive and to digitize speech signals corresponding to a spoken utterance; a speech recognizer configured to receive and recognize the digitized speech signals; and wherein the speech recognizer is configured to recognize the digitized speech signals based on speech templates stored in the database and a predetermined grammatical structure.

### PRIORITY

The present U.S. patent application claims priority from European Patent Application No. 08 021 450.5 entitled GRAMMAR AND TEMPLATE-BASED SPEECH RECOGNITION OF SPOKEN UTTERANCES filed on Dec. 10, 2008, which is incorporated herein by reference in its entirety.

### TECHNICAL FIELD

The present invention relates to the art of automatic speech recognition and, in particular, recognition of spoken utterances in speech-to-text systems allowing a user the dictation of texts as E-Mails and SMS

### BACKGROUND ART

The human voice can probably be considered as the most natural and comfortable man-computer interface. Voice input provides the advantages of hands-free operation, thereby, e.g., providing access for physically challenged users or users that are using there hands for different operation, e.g., driving a car. Thus, computer users for a long time desired software applications that can be operated by verbal utterances. In particular, communication with remote parties by means of electronic mail, SMS, etc. can be realized by spoken utterances that have to be recognized in transformed into text that eventually is sent to a remote party.

For example, navigation systems in vehicles become increasingly prevalent. Usually on board navigation computer systems analyze the combined data provided by GPS (Global Positioning System), motion sensors as ABS wheel sensors as well as a digital map and thereby determine the current position and velocity of a vehicle with increasing preciseness. The vehicle navigation systems may also be equipped to receive and process broadcasted information as, e.g., the traffic information provided by radio stations, and also to send emails, etc. to a remote party.

Besides acoustic communication by verbal utterances text messages sent by means of the Short Message Service (SMS) employed by cell phones are very popular. However, in particular, the driver of a vehicle is not able to send an SMS message by typing the text message by means of the relatively tiny keyboard of a standard cell phone. Even if the driver can use a larger keyboard when, e.g., the cell phone is inserted in an appropriate hands-free set or when the vehicle communication system is provided with a touch screen or a similar device, manually editing a text that is intended to be sent to a remote communication party would distract the driver's attention from steering the vehicle. Therefore, writing an E-Mail or an SMS would result in some threat to the driving safety, in particular, in heavy traffic.

There is, therefore, a need to provide passengers in vehicles, in particular, in automobiles, with an improved alternative kind of communication, in particular, communication with a remote party during a travel by means of text messages generated from verbal utterances from a user during a travel with the automobile.

Present-day speech recognition systems usually make use of a concatenation of allophones that constitute a linguistic word. The allophones are typically represented by Hidden Markov Models (HMM) that are characterized by a sequence of states each of which has a well-defined transition probability. In order to recognize a spoken word, the systems have to compute the most likely sequence of states through the HMM. This calculation is usually performed by means of the Viterbi algorithm, which iteratively determines the most likely path through the associated trellis.

Speech recognizing systems conventionally choose the guess for an orthographic representation of a spoken word or sentence that corresponds to sampled acoustic signals from a finite vocabulary of words that can be recognized and are stored, for example, as data/vocabulary lists. In the art comparison of words recognized by the recognizer and words of a lexical list usually take into account the probability of mistaking one word, e.g. a phoneme, for another.

The above-mentioned vocabulary lists become readily very long for practical applications. Consequently, conventional search processes can take an unacceptable long time. Particularly, due to the relatively limited computational resources available in embedded systems, as vehicle communication system and vehicle navigation systems, for example, reliable automated speech recognition of verbal utterances poses a complex technical problem. It is therefore a goal to be achieved with the present invention to provide speech recognition of verbal utterances for speech-to-text applications that allow efficient and reliable recognition results and communication with a remote party by text messages even if only limited computational resources are available.

### SUMMARY OF THE INVENTION

In a first embodiment of the invention there is provided a communication system for creating speech to text messages, such as SMS, EMS, MMS, and e-mail in a hands-free environment. The system includes a database comprising classes of speech templates classified according to a predetermined grammar. An input receives and converts a spoken utterance to a digital speech signals. The system also includes a speech recognizer that is configured to receive and recognize the digitized speech signals. The speech recognizer recognizes the digitized speech signals based on speech templates stored in the database and a predetermined grammatical structure. The speech templates may be classified according to grammatical function or to context. The system may also include a text message generator that is configured to generate a text message based on the recognition of the digitized speech signals.

In certain embodiments of the invention, the communication system is configured to prompt the user to input, by verbal utterances, a sequence of a predetermined number of words at least partly of different grammatical functions in a predetermined order. In such an embodiment, the speech recognizer is configured to recognize the digitized speech signals corresponding to the sequence of words in the predetermined order or in a particular context. The input for receiving the spoken utterance may be one of a connector to a cell phone, a Bluetooth connector and a WLAN connector. The system may be embodied as part of a vehicle navigation system or a cellular phone for example. Embodiments of the invention are particularly suited to embedded systems that have limited processing power and memory storage, since the speech recognizer can employ the speech templates with a specified grammatical structure as opposed to performing a more complicated speech analysis.

The methodology for recognizing the spoken utterances requires that a series of speech templates classified according to a predetermined grammar are retrieved from memory by a processor. A speech signal is obtained that corresponds to a spoken utterance and the speech signal is the recognized based on the retrieved speech templates. In certain embodiments, the processor may prompt a user to input, by verbal utterances, a sequence of a predetermined number of words at least partly of different grammatical functions in a predetermined order. Based upon the presented order, the processor can determine or define a particular context for the words. The processor can then recognize the speech signals corresponding to the sequence of words in the predetermined order. Further, the templates can be classified according to their grammatical functions. The methodology may also include generating a text message based on the recognition result and transmitting the text message to a receiver. The text message may be displayed on a display and the user may be prompted to acknowledge the text message. The methodology can be embodied as a computer program product wherein the computer program product is a tangible computer readable medium having executable computer code thereon.

### BRIEF DESCRIPTION OF THE DRAWINGS

The foregoing features of the invention will be more readily understood by reference to the following detailed description, taken with reference to the accompanying drawings, in which:

FIG. 1 is a diagram showing a computer system for recognizing speech signals;

FIG. 2 is a flow chart of the method for recognizing speech signals;

FIG. 3 shows a flow diagram illustrating an example of the method of transmitting a text message according to the invention; and

FIG. 4 illustrates an example for the template based speech recognition according to the invention.

### DETAILED DESCRIPTION OF SPECIFIC EMBODIMENTS

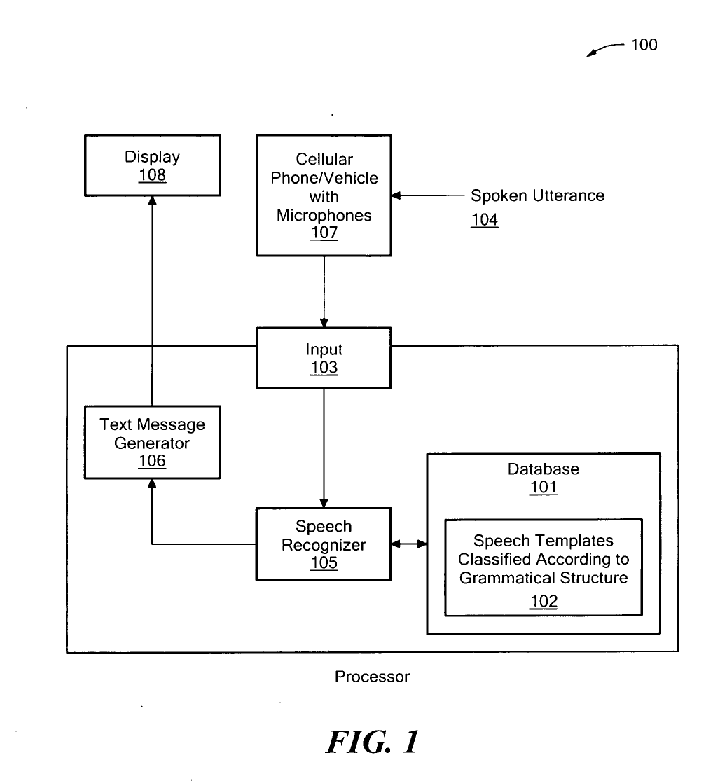

Embodiments of the present invention as shown in FIG. 1 provide a communication system 100 that includes a database 101 having classes of speech templates classified according to a predetermined grammar 102. The system also includes an input 103 that is configured to receive and to digitize speech signals corresponding to a spoken utterance 104. In response to the input spoken utterance a speech recognizer 105 recognizes the digitized speech signals based on speech templates 102 stored in the database 101 and a grammatical structure of the spoken utterance.

The input may comprise a speech input and/or a telephone unit and/or a connector to a cell phone and/or a Bluetooth connector and/or a WLAN connector. The communication system 100 may further comprise or be connected to a text message generator 106 configured to generate a text message based on the recognition of the digitized speech signals. The text message may be generated as an SMS message, an EMS message, an MMS message or an E-Mail, for example and displayed on a display device 108. In certain embodiments the speech recognizer, text message generator, input and/or the data bases and speech templates may reside and operate within one or more processors. Each element may exist as a separate logic module and can be constructed as a series of logical circuit elements on chip.

The speech signals are obtained by means of one or more microphones, for example, installed in a passenger compartment of a vehicle and configured to detect verbal utterances of the passengers 107. Advantageously, different microphones are installed in the vehicle and located in the vicinities of the respective passenger seats. Microphone arrays may be employed including one or more directional microphones in order to increase the quality of the microphone signal (comprising the wanted speech but also background noise) which after digitization is to be processed further by the speech recognizer.

In principle, the speech recognizer can be configured to recognize the digitized speech signals on a letter-by-letter and/or word-by-word basis. Whereas in the letter-by-letter mode the user is expected to spell a word letter-by-letter, in the word-by-word mode pauses after each spoken word are required. The letter-by-letter mode is relatively uncomfortable but reliable. Moreover, it may be preferred to employ recognition of the digitized speech signals sentence-by-sentence.

It may also be foreseen that probability estimates or other reliability evaluations of the recognition results are assigned to the recognition results that may, e.g., be generated in form of N-best lists comprising candidate words. If the reliability evaluations for one employed speech recognition mode fall below a predetermined threshold the recognition process may be repeated by a different mode and/or the may be prompted to repeat an utterance.

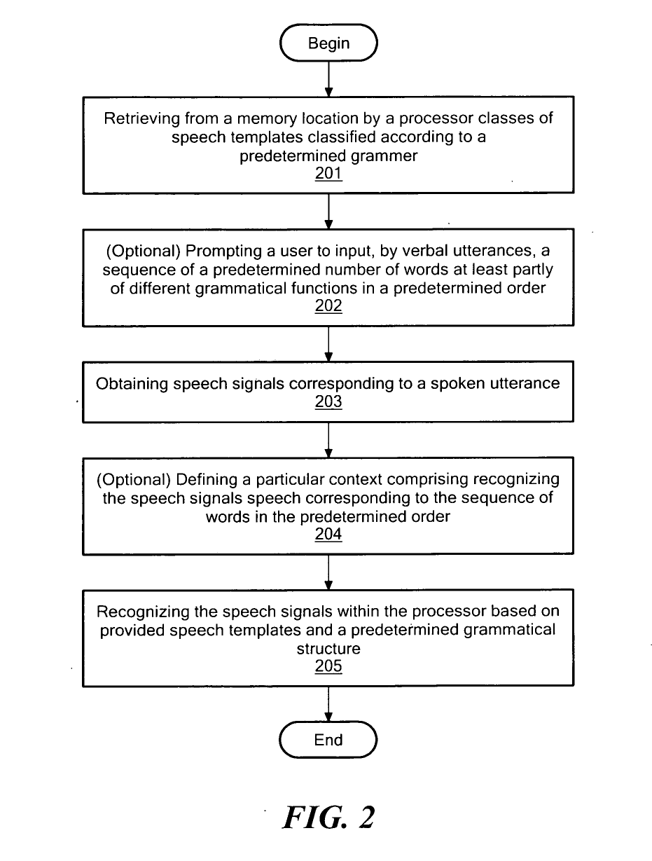

The digitized speech signals are analyzed for the recognition process as shown in the flow chart of FIG. 2. For this recognition process, feature (characteristic) vectors comprising feature parameters may be extracted and spectral envelopes, formants, the pitch and short-time power spectrum, etc., may be determined in order to facilitate speech recognition, in principle.

The guess for an orthographic representation of a spoken word or sentence that corresponds to sampled acoustic signals is chosen from a finite vocabulary of words that can be recognized and is structured according to the classes of templates stored in the database, for example, in form of a data list for each class, respectively. The speech templates may represent parts of sentences or even complete sentences typically used in E-Mails, SMS messages, etc.

A text message can be generated on the basis of the recognition result. The text generator may be incorporated in the speech recognizer and does not necessarily represent a separate physical unit. The text message generated by the text message generator on the basis of the recognition result obtained by the speech recognizer can be encoded as an SMS (Short Message Service) message, an EMS (Enhanced Message Service), an MMS (Multimedia Message Service) message or an E-Mail comprising, e.g., ASCII text or another plain text or a richer format text. Encoding as an EMS message allows for a great variety of appended data files to be sent together with the generated text message.

Operation of the communication system for the transmission of a text message does not require any text input by the user. In particular, the driver of a vehicle is, thus, enabled to send a text message to a remote party without typing in any characters. Safety and comfort are, therefore, improved as compared to systems of the art that require haptic inputs by touch screens, keyboards, etc.

It is essential for the present invention that the recognition process is based on a predetermined grammatical structure of some predetermined grammar. The speech samples may be classified according to the grammar and stored in memory and retrieved by a processor 201. Recognition based on the predetermined grammatical structure, necessarily, implies that a user is expected to obey a grammatical structure of the predetermined grammar when performing verbal/spoken utterances that are to be recognized. It is the combined grammar and template approach that facilitates recognition of spoken utterances and subsequent speech-to-text processing and transmitting of text messages in embedded systems or cellular phones, for example.

Herein, by grammatical structure a sequence of words of particular grammatical functions, clause constituents, is meant. Thus, speech recognition is performed for a predetermined sequence of words corresponding to speech samples of different classes stored in the database. The grammatical structure may be constituted by a relatively small limited number of words, say less than 10 words. To give a particular example in more detail, a user is expected to sequentially utter a subject noun, a predicate (verb) and an object noun. This sequence of words of different grammatical functions (subject noun, verb, object noun) represents a predetermined grammatical structure of a predetermined grammar, e.g., the English, French or German grammar. A plurality of grammatical structures can be provided for a variety of applications (see description below) and used for the recognition process.

The automated speech recognition process is, thus, performed by matching each word of a spoken utterance only with a limited subset of the entirety of the stored templates, namely, in accordance with the predetermined grammatical structure 205. Therefore, the reliability of the recognition process is significantly enhanced, particularly, if only limited computational resources are available, since only limited comparative operations have to be performed and only for respective classes of speech templates that fit to the respective spoken word under consideration for speech recognition. Consequently, the speech recognition process is fastened and less error-prone as compared to conventional recognition systems/methods employed in present-day communication systems.

In particular, the user can be expected to utter a sequence of words in a particular context 203. More particularly the user may be asked by the communication system about the context, e.g., by a displayed text message or synthesized speech output 202. The above-mentioned subject noun, the predicate and the object noun, for example, are recognized by templates classified in their respective classes dependent on the previously given context/application 204. Moreover, a set of alternative grammatical structures may be provided (and stored in a database to be used for the recognition process) for a particular context, e.g., according to a sequence of several template sentences by which a user can compose complex SMS messages as
“I am in the car. I will arrive at home. I love you. [symbol] ”

As shown in this example, the templates, in general, may also include emoticons.

The communication system may also be configured to prompt a warning or a repeat command, if no speech sample is identified to match the digitized speech signal with some confidence measure exceeding a predetermined confidence threshold.

Consider a case in that a user is willing to send an E-Mail to a remote communication party in which he wants to indicate the expected arrival time at a particular destination. In this case, he could utter a keyword, “Arrival time”, thereby initiating speech recognition based on templates that may be classified in a corresponding class stored in the database. The speech recognizer may be configured to expect: Subject noun for the party (usually including the user) who is expected to arrive at some expectation time, predicate specifying the way of arriving (e.g., “come/coming”, “arrive/arriving”, “land/landing”, “enter/entering port”, etc.) and object noun (city, street address, etc.), followed by the time specification (date, hours, temporal adverbs line “early”, “late”, etc.).

It is noted that a large variety of contexts/applications shall be provided in order to allow for reliable recognition of different kinds of dictations. The grammatical structures shall mirror/represent contexts/applications frequently used in E-Mails, SMS messages, etc., i.e. contexts related to common communication schemes related to appointments, spatial and temporal information, etc. Such contexts usually show particular grammatical structures in E-Mails, SMS messages, etc., and these grammatical structures are provided for the speech recognition process.

In particular, the communication system of the present invention may be configured to prompt the user to input, by verbal utterances, a sequence of a predetermined number of words at least partly of different grammatical functions in a predetermined order and wherein the speech recognizer is configured to recognize the digitized speech signals corresponding to the sequence of words in the predetermined order 202, 204, 205.

Different from conventional speech recognizer that are configured to recognize an arbitrary sequence of words, according to this example of the invention a predetermined order of a predetermined number of words only that is input by verbal utterances is considered for the recognition process. Moreover, elements of the grammatical structures provided for the speech recognition and, e.g., stored in a database of the communication system, can be considered as placeholders to be filled with the words actually uttered by the user.

The reliability of the speech recognition process, thereby, is further enhanced, since the variety of expected/possible speech inputs is significantly reduced. It might also be preferred to provide the opportunity that an unexpected input word (of an unexpected grammatical form, i.e. being an unexpected clauses constituent) and/or failure of recognition of a word being part of an utterance results in a warning output of the communication system (displayed on a display and/or output by synthesized speech) and/or in intervention by the communication system, for example, in form of a speech dialog.

Moreover, the communication system may be configured to prompt the user to define a particular context and, in this case, the speech recognizer is configured to recognize the digitized speech signals (utterances spoken by the user) based on the defined particular context.

In the above example, prompts can be given by the communication system by simply waiting for an input, by displaying some sign (of the type of a “blinking cursor”, for example), by an appropriate synthesized speech output, by displaying a message, etc. The prompt may even include announcement of the grammatical function of an expected utterance in accordance with the grammatical structure. In fact, the expected grammatical structure may be displayed in form of a display of the expected grammatical function of the words of a sequence of words according to the grammatical structure (e.g., “Noun”-“Verb”-“Object”) Hereby, success of the recognition process is even further facilitated albeit at the cost of comfort and smoothness of the dictation process.

The communication system provided herein is of particular utility for navigation systems installed in vehicles, as for example, automobiles. Moreover, cellular phones can advantageously make use of the present invention and, thus, a cellular phone comprising a communication system according to one of the preceding examples is provided.

In the above-mentioned examples of the method the speech templates can advantageously be classified according to their grammatical functions (classes of clause constituents) and/or contexts of communication. The contexts may be given in form of typical communication contexts of relevance in E-Mail or SMS communication. Provision of context dependent grammatical structures may be based on an analysis of a pool of real-world E-Mails or SMS messages, etc., in order to provide appropriate grammatical structures for common contexts (e.g., informing on appointments. locations, invitations, etc.).

Furthermore, it is provided a method for transmitting a text message comprising the steps of one of the examples of the method for speech recognition, and further comprising the steps of generating a text message based on the recognition result and transmitting the text message to a receiving party. Transmission is preferably performed in a wireless manner, e.g., via WLAN or conventional radio broadcast.

The method for transmitting a text message may further comprise displaying at least part of the text message on a display and/or outputting a synthesized speech signal based on the text message and prompting a user to acknowledge the text message displayed on the display and/or the output synthesized speech signal. In this case, the step of transmitting the text message is performed in response to a predetermined user's input in response to the displayed text message and/or the output synthesized speech signal.

The present invention can, for example, be incorporated in a vehicle navigation system or another in-car device that may be coupled with a cellular phone allowing for communication with a remote party via E-Mail, SMS messages, etc. A vehicle navigation system configured according to present invention comprises a speech input and a speech recognizer. The speech input is used to receive a speech signal detected by one or more microphones installed in a vehicular cabin and to generate a digitized speech signal based on the detected speech signal. The speech recognizer is configured to analyze the digitized speech signal for recognition. For the analyzing process feature vectors comprising characteristic parameters as cepstral coefficients may be deduced from the digitized speech signal.

The speech recognizer has access to a speech database in which speech samples are stored. Comparison of the analyzed speech signal with speech samples stored in the speech database is performed by the speech recognizer. The best fitting speech sample is determined and the corresponding text message is generated from the speech samples and transmitted to a remote party.

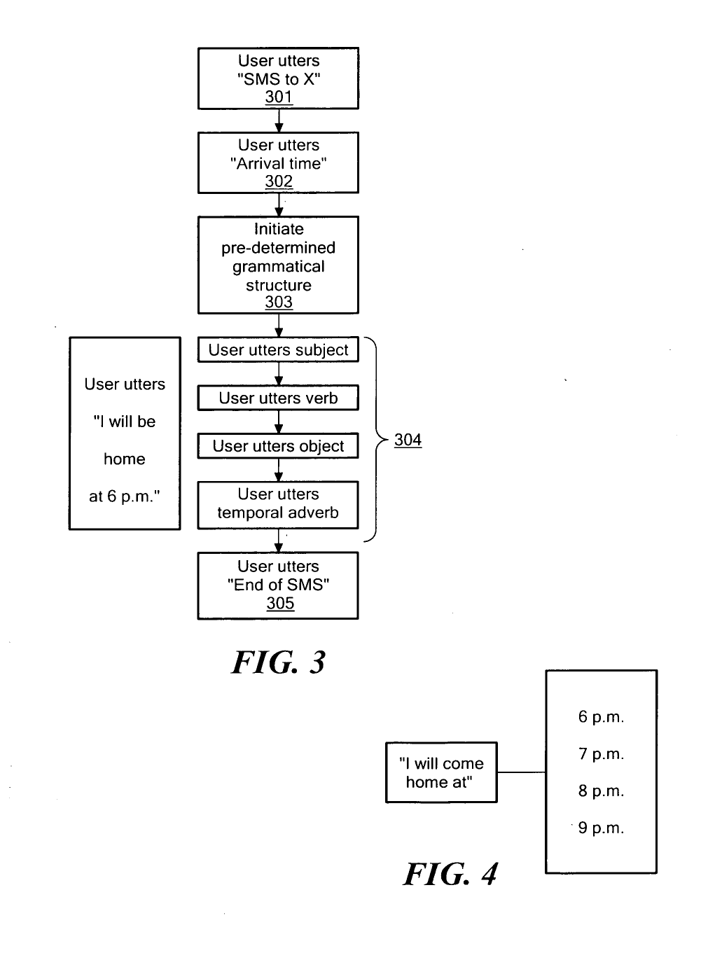

With reference to FIG. 3, consider an example in that a user of the navigation system, e.g., a driver of the vehicle in which the vehicle navigation system is installed, may intend to send an SMS message to another person (named X in the present example). He utters the keyword “SMS” followed by the addressee 301. Thereby, an SMS transmission function and, in particular, processing for speech recognition of utterances that are to be translated to a text massage that can be transmitted is initiated. In particular, the phone number of X will be looked up in a corresponding telephone list. Alternatively, dictation of an E-Mail could be announced by the utterance “E-Mail to X” and the corresponding E-Mail address may be automatically looked up.

It may be preferred that activation of the speech recognizer is performed by the utterance of a keyword. In this case, the system has to be in a stand-by mode, i.e. the microphone and the speech input are active. The speech input in this case may recognize the main keyword for activating the speech recognizer by itself without the help of an actual recognizing process and a speech database, since the main keyword should be chosen to be very distinct and the digital data representation thereof can, e.g., be permanently held in the main memory.

Next, the user utters 302 another keyword, namely, “Arrival time”. According to the present example, the speech recognizer is configured to expect a particular predetermined grammatical structure of the following utterances that are to be recognized in reaction of the recognition of the keyword “Arrival time”, i.e. a particular one of a set of predetermined grammatical structures is initiated 303 that is to be observed by the user to achieve correct recognition results. For example, the predetermined grammatical structure to be observed by the user after utterance of the keyword “Arrival time” is the following: ‘Subject’ followed by ‘verb’ followed by ‘object’ followed by ‘temporal adverb’.

The user may utter 304 “I will be home at 6 p.m.”. This spoken sentence will be recognized by means of a set of speech templates looked-up by the speech recognizer. The users concludes 305 the text of the SMS message by the keyphrase “End of SMS”. It is noted that the user may utter the whole sentence “I come home at 7 p.m” without any pauses between the individual words. Recognition of the entire sentence is performed on the basis of the speech templates provided for the words of the sentence.

It is noted that the user's utterances are detected by one or more microphones and digitized and analyzed for speech recognition. The speech recognizer may work on a word-by-word basis and by comparison of each analyzed word with the speech samples classified according to the grammatical structure and the templates stored in the speech database. Accordingly, a text message is generated from stored speech samples that are identified by the speech recognizer to correspond to each word of the driver's utterance, respectively.

After the user's utterances have been recognized by the speech recognizer the navigation system or other in-car device may output a synthesized verbal utterance, e.g., “Text of SMS (E-Mail): I come home at 7 p.m”. Alternatively or additionally, the recognized text may be displayed to the user on some display device. Thus, the driver can verify the recognized text, e.g., by utterance of the keyword “Correct”. The generated text message can subsequently be passed to a transmitter for transmission to a remote communication party, i.e. in the present case, to a person named X.

Whereas in the above-described example the present invention is described to be incorporated in a vehicle navigation system, it can, in fact, be incorporated in any communication system comprising a speech recognizer. In particular, the present invention can be incorporated in a cellular phone, a Personal Digital Assistant (PDA), etc.

It is an essential feature of the present invention that the automated recognition of a user's utterances is based on speech templates. Parts of typical sentences of E-Mails, for example, are represented by the templates. FIG. 4 shows an example in that a speaker has uttered the incomplete sentence “I will come home at”. After a pause after the preposition “at” he is expected to specify the time of arrival at home. According to this example, a speech recognizer incorporating the present invention will expect the time of day of the arrival of the user. It might be configured to prompt a warning or a repeat command in the case the user's utterance cannot be recognized as a time of day.

Alternatively to the shown example, the user may be expected to finish an incomplete sentence “I will come home” by “at 7 p.m.” or “at 8 p.m.”, etc. In any case, a speech recognizer incorporating the present invention will recognize the utterance completing the sentence, i.e. “7 p.m.” or “at 7 p.m.”, for example, based on speech templates that represent such standard phrases commonly used in E-Mails, SMS messages, etc. It should be noted that, in general, these speech templates may represent parts of sentences or even complete sentences.

The embodiments of the invention described above are intended to be merely exemplary; numerous variations and modifications will be apparent to those skilled in the art. All such variations and modifications are intended to be within the scope of the present invention as defined in any appended claims.

It should be recognized by one of ordinary skill in the art that the foregoing methodology may be performed in a signal processing system and that the signal processing system may include one or more processors for processing computer code representative of the foregoing described methodology. The computer code may be embodied on a tangible computer readable medium i.e. a computer program product.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an embodiment of the present invention, predominantly all of the reordering logic may be implemented as a set of computer program instructions that is converted into a computer executable form, stored as such in a computer readable medium, and executed by a microprocessor within the array under the control of an operating system.

Computer program logic implementing all or part of the functionality previously described herein may be embodied in various forms, including, but in no way limited to, a source code form, a computer executable form, and various intermediate forms (e.g., forms generated by an assembler, compiler, networker, or locator.) Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL.).

What is claimed is:

1. A communication system, comprising
a database comprising classes of speech templates classified according to a predetermined grammar;
an input configured to receive and to digitize speech signals corresponding to a spoken utterance; and
a speech recognizer configured to receive and recognize the digitized speech signals;
wherein the speech recognizer is configured to recognize the digitized speech signals based on speech templates stored in the database and a predetermined grammatical structure.

2. A communication system according to claim 1, further comprising:
a text message generator configured to generate a text message based on the recognition of the digitized speech signals.

3. A communication system according to claim 1, wherein the communication system is configured to prompt the user to input, by verbal utterances, a sequence of a predetermined number of words at least partly of different grammatical functions in a predetermined order and wherein the speech recognizer is configured to recognize the digitized speech signals corresponding to the sequence of words in the predetermined order.

4. A communication system according to claim 1, wherein the communication system is configured to prompt the user to define a particular context and wherein the speech recognizer is configured to recognize the digitized speech signals based on the defined particular context.

5. A communication system according to claim 1, wherein the speech templates are classified according to at least one of grammatical functions and contexts.

6. A communication system according to claim 1, wherein the input comprises at least one of a connector to a cell phone, a Bluetooth connector and a WLAN connector.

7. A communication system according to claim 2, wherein the text message generator is configured to generate the text message as at least one of an SMS message, an EMS message, an MMS message or an E-Mail.

8. A vehicle navigation system comprising the communication system according to claim 1.

9. A cellular phone comprising the communication system according claim 1.

10. A computer-implemented method for speech recognition of spoken utterances, comprising
retrieving from a memory location by a processor classes of speech templates classified according to a predetermined grammar;
obtaining speech signals corresponding to a spoken utterance; and
recognizing the speech signals within the processor based on provided speech templates and a predetermined grammatical structure.

11. A method according to claim 10 further comprising:
prompting a user to input, by verbal utterances, a sequence of a predetermined number of words at least partly of different grammatical functions in a predetermined order; and
defining a particular context comprising recognizing the speech signals speech corresponding to the sequence of words in the predetermined order.

12. A method according to claim 10, wherein the speech templates are classified according to their grammatical functions.

13. A method for transmitting a text message according to claim 10 further comprising:
generating a text message based on the recognition result; and
transmitting the text message to a receiver.

14. A method according to claim 13, further comprising:
displaying at least part of the text message on a display and prompting a user to acknowledge the text message displayed on the display; and
wherein transmitting of the text message is performed in response to a predetermined user's input in response to the displayed text message.

15. A method according to claim 13, further comprising:
outputting a synthesized speech signal based on the text message and prompting a user to acknowledge the output synthesized speech signal; and
wherein transmitting of the text message is performed in response to a predetermined user's input in response to the output synthesized speech signal.

16. A computer program product comprising a tangible computer readable medium having computer code there on for speech recognition of spoken utterances, the computer code comprising:
computer code for providing classes of speech templates classified according to a predetermined grammar;
computer code for obtaining speech signals corresponding to a spoken utterance; and
computer code for recognizing the speech signals based on the provided speech templates and a predetermined grammatical structure.

17. A computer program product according to claim 16 further comprising:
computer code for prompting a user to input, by verbal utterances, a sequence of a predetermined number of words at least partly of different grammatical functions in a predetermined order; and
computer code for defining a particular context comprising recognizing the speech signals speech corresponding to the sequence of words in the predetermined order.

18. A computer program product according to claim 16, wherein the speech templates are classified according to their grammatical functions.

19. A computer program product for transmitting a text message according to claim 16 further comprising:
computer code for generating a text message based on the recognition result; and
transmitting the text message to a receiver.

20. A computer program product according to claim 19, further comprising:
computer code for displaying at least part of the text message on a display and prompting a user to acknowledge the text message displayed on the display; and
wherein transmitting of the text message is performed in response to a predetermined user's input in response to the displayed text message.

21. A computer program product according to claim 19, further comprising:
computer code for outputting a synthesized speech signal based on the text message and prompting a user to acknowledge the output synthesized speech signal; and
wherein transmitting of the text message is performed in response to a predetermined user's input in response to the output synthesized speech signal.
